(19) United States
(12) Patent Application Publication
(10) Pub. No.: US 2002/0142678 A1
(43) Pub. Date: Oct. 3, 2002

(54) Blade base for a plug

(76) Inventor: Kang-Wen Liu, Yun Lin Shiann (TW)

Correspondence Address: Alan D. kamrath, Rider, Bennett, Egan & Arundel, LLP, Suite 2000, 333 South Seventh Street, Minneapolis, MN, 55402, US

(21) Appl. No.: 10/108,169

(22) Filed: Mar. 27, 2002

(30) Foreign Application Priority Data
Apr. 2, 2001 (TW) 090205199

(51) Int. Cl. H01R 9/24

(52) U.S. Cl. 439/884; 439/866

(57) ABSTRACT

A blade base for a plug is made of insulating material and comprises a first side and a second side. At least two slots extend from the first side through the second side of the blade base. At least two extensions project from the first side of the blade base. Each extension surrounds an associated slot for covering a rear portion of a front end of an associated one of at least two blades that respectively extend through the slots.

### BACKGROUND OF THE INVENTION

1. Field of the Invention

The present invention relates to a blade base for a plug. In particular, the present invention relates to an insulating blade base having at least two extensions each for covering a section of a respective plug blade, thereby preventing electric shock during use.

2. Description of the Related Art

FIG. 1 of the drawings illustrates a conventional insulating blade base 2 comprising two slots 21 through which front ends 11 of two blades 1 extend. An end of a wire 5 is attached to the rear end 12 of each blade 1. A flange 22 is formed on a side of the blade base 2 and extends along a periphery defining a respective slot 21. A molding process is carried out to form a housing 8 for enclosing the wires 5, the rear ends 12 of the blades 1, and the blade base 2, as shown in FIG. 5. The flanges 22 allow easy molding injection to prevent deficiency resulting from non-smooth corners (see FIGS. 2 through 4) of each blade 1 during the molding injection. However, in use, the front end 11 of the respective blade 1 is not completely hidden in the respective receptacle such that the user could be injured by electric shock. The present invention provides an improved design to solve this problem.

### SUMMARY OF THE INVENTION

An object of the present invention is to provide an insulating blade base having at least two extensions each for covering a section of a respective plug blade, thereby preventing electric shock during use.

In accordance with a first aspect of the invention, a blade base for a plug made of insulating material is provided and comprises a first side and a second side. At least two slots extend from the first side through the second side of the blade base. At least two extensions project from the first side of the blade base. Each extension surrounds an associated slot for covering a rear portion of a front end of an associated one of at least two blades that respectively extend through the slots.

In accordance with a second aspect of the invention, a combination of a blade base and at least two blades is provided. The blade base is made of insulating material and comprises a first side and a second side. At least two slots extend from the first side through the second side of the blade base. At least two extensions project from the first side of the blade base. Each extension surrounds an associated slot.

Each blade has a front end extending through an associated slot. Each extension covers a rear portion of the front end of an associated blade when the blades are inserted into a receptacle, wherein the rear portion of the front end of each blade is located outside the receptacle when the blades are inserted into the receptacle.

Other objects, advantages, and novel features of the invention will become more apparent from the following detailed description when taken in conjunction with the accompanying drawings.

### BRIEF DESCRIPTION OF THE DRAWINGS

FIG. 1 is an exploded perspective view of a conventional blade base and two blades.

FIG. 2 is a sectional view taken along plane 2-2 in FIG. 1.

FIG. 3 is an enlarged view of a circle in a lower left comer of FIG. 2.

FIG. 4 is an enlarged view of a circle in an upper right comer of FIG. 2.

FIG. 5 is a side view, partly sectioned, of a plug housing made from the blade base and the blades in FIG. 1.

FIG. 6 is an exploded perspective view of two blades and a blade base in accordance with the present invention.

FIG. 7 is a perspective view of the blades and the blade in FIG. 6.

FIG. 8 is a sectional view, partly sectioned; of a plug housing made from the blade base and the blades in FIG. 6.

FIG. 9 is an exploded perspective view of three blades and a modified embodiment of the blade base in accordance with the present invention.

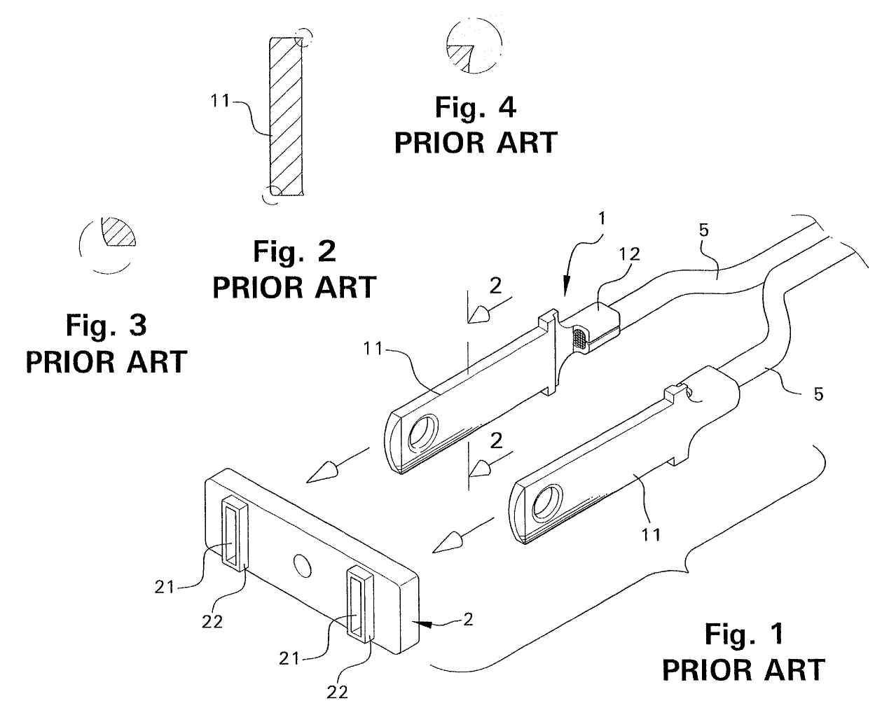

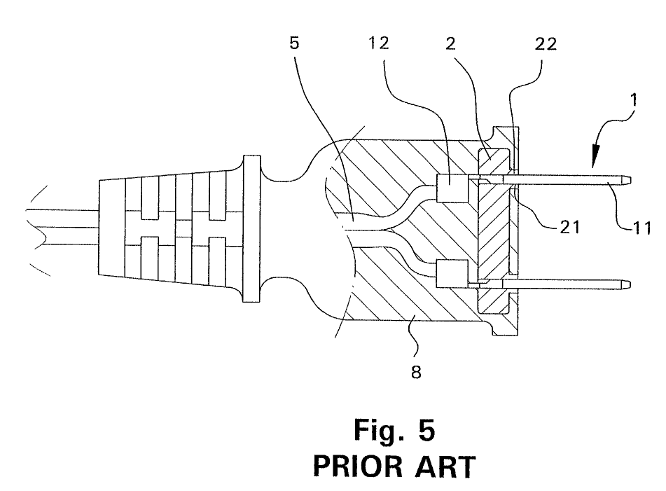

### DETAILED DESCRIPTION OF THE PREFERRED EMBODIMENTS

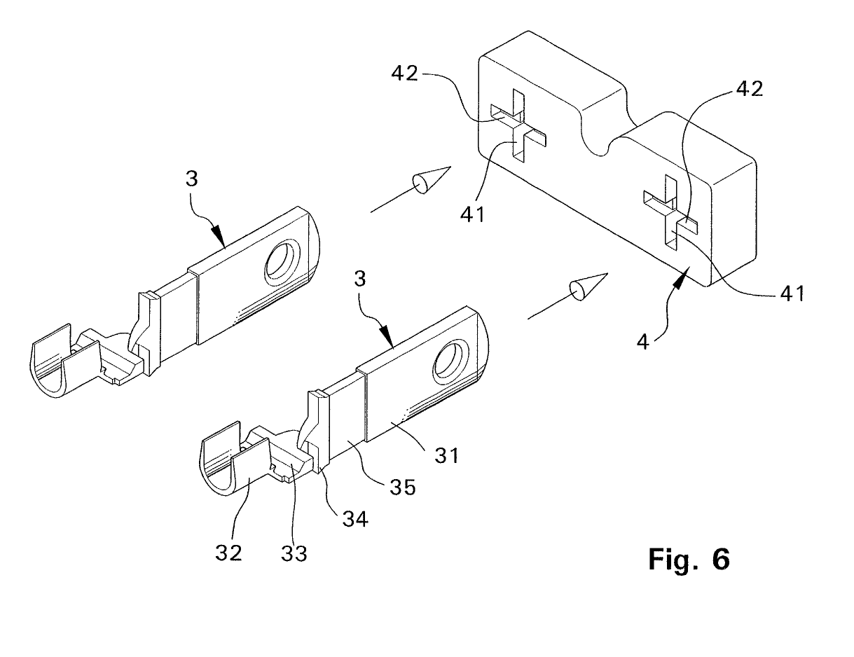

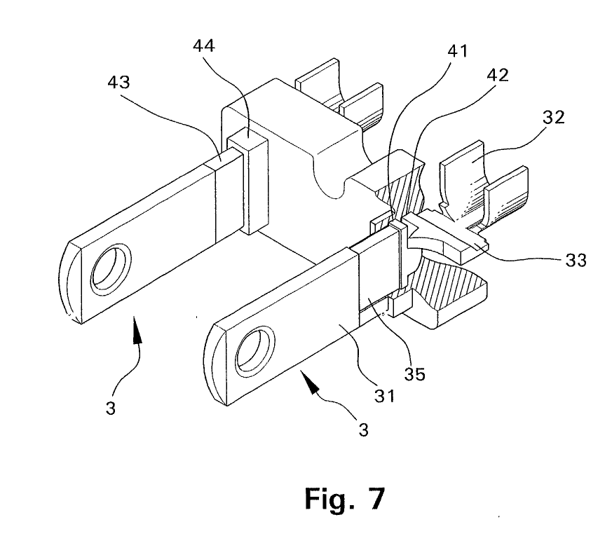

Referring to FIGS. 6 and 7, a blade base 4 for a plug in accordance with the present invention generally includes two slots 41 extending from a first side through a second side opposite to the first side. The blade base 4 further includes two grooves 42 in the second side thereof. Each groove 42 is perpendicular to a respective slot 41, thereby forming a cruciform groove on the second side of the blade base 4, best shown in FIG. 6.

As illustrated in FIG. 7, the blade base 4 further includes two flanges 44 formed on the first side thereof. Each flange 44 extends along a periphery defining a respective slot 41. Further, an extension 43 projects from an end face of each flange 44 and extends away from the blade base 4.

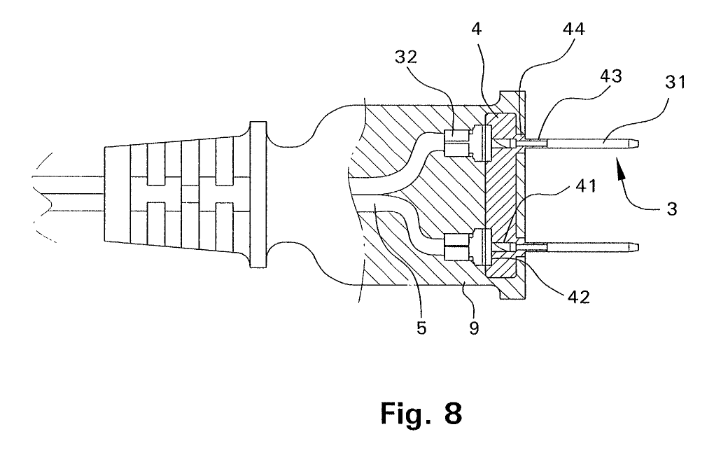

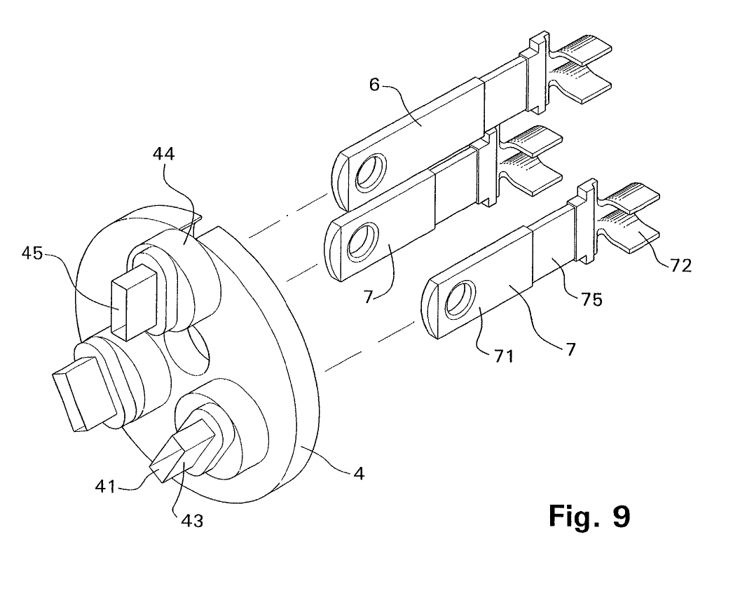

As illustrated in FIG. 8, each blade 4 has a front end 31 inserted through a respective slot 41 and a rear end 32 to which an end of a wire 5 is attached. Each blade 3 further includes a biting section 34 and a positioning section 33 between the front end 31 thereof and the rear end 32 thereof. The biting section 34 bites a wall defining an associated one of the slots 41. The positioning section 33 is located in an associated one of the grooves 42. A molding process is carried out to form a housing 9 for enclosing the wires 5, the blade base 4, and a rear portion of the front end 31 of each blade 3. As illustrated in FIG. 8, the housing 9 also encloses the flanges 44. The rear end 32 of each blade 3 is U-shaped and extends along a plane perpendicular to a longitudinal direction of the blade 7. When in use, the exposed portion of each blade 3 outside a respective receptacle (not shown) is covered by the respective extension 43. Thus, the risk of electric shock resulting from the exposed portion of each blade 3 is avoided by the respective extension 43. It is noted that the blade base 4, the flanges 44, and the extensions 43 are integrally formed of an insulating material by means of molding injection. Of course, the front end 31 may have a recessed section 35 in the rear end thereof for receiving the respective extension 43 such that the respective extension 43 is flush with two sides of the front end 31 of the respective blade 3. The flange 44 in this embodiment can be omitted.

FIG. 9 illustrates a modified embodiment of the invention, wherein the blade base 4 includes three slots 41 for holding front ends 71 of three blades 7 and 6. One of the blades, i.e., blade 6 is a grounding blade. An extension 43 projects from an end face of an associated one of three flanges 44 on a side of the blade base 4. The front end 71 has a recessed section 75 at a rear portion thereof. Each blade 7 has a U-shaped rear end 72 that extends along plane parallel to a longitudinal direction of the blade 7. Namely, the blade base 4 in accordance with the present invention can be used with three blades. The flange 44 in this embodiment can be omitted.

Although the invention has been explained in relation to its preferred embodiment, it is to be understood that many other possible modifications and variations can be made without departing from the scope of the invention as hereinafter claimed.

What is claimed is:

1. A blade base for a plug, said blade base being made of insulating material and comprising a first side and a second side, at least two slots extending from said first side through said second side of said blade base, at least two extensions projecting from said first side of said blade base, each of said at least two extensions surrounding an associated one of said at least two slots for covering a rear portion of a front end of an associated one of at least two blades that respectively extend through said at least two slots.

2. A combination of a blade base and at least two blades, comprising:
a blade base made of insulating material and comprising a first side and a second side, at least two slots extending from said first side through said second side of said blade base, at least two extensions projecting from said first side of said blade base, each of said at least two extensions surrounding an associated one of said at least two slots;
at least two blades each having a front end extending through an associated one of said at least two slots, each of said at least two extensions covering a rear portion of said front end of an associated one of said at least two blades when said at least two blades are inserted into a receptacle, wherein said rear portion of said front end of each of said at least two blades is located outside the receptacle when said at least two blades are inserted into the receptacle.

3. The combination as claimed in claim 2, wherein said blade base includes at least two flanges on the first side thereof, and wherein each of said at least two extensions extend from an end face of an associated one of said at least two flanges.

4. The combination as claimed in claim 3, wherein said blade base further includes at least two grooves in the second side thereof, each of said at least two grooves being perpendicular to an associated one of said at least two slots, thereby forming a cruciform groove on said first side of said blade base.

5. The combination as claimed in claim 4, wherein each of said at least two blades includes a rear end, each of said at least two blades further including a biting section and a positioning section between said front end thereof and said rear end thereof, said biting section biting a wall defining an associated one of said at least two slots, said positioning section being located in an associated one of said at least two grooves.

6. The combination as claimed in claim 5, wherein said front end of each of said at least two blades includes a recessed section on a rear portion thereof for receiving an associated one of said at least two extensions of said blade base such that each of said at least two extensions is flush with two sides of said front end of an associated one of said at least two blades.

7. The combination as claimed in claim 2, wherein said front end of each of said at least two blades includes a recessed section on a rear portion thereof for receiving an associated one of said at least two extensions of said blade base such that each of said at least two extensions is flush with two sides of said front end of an associated one of said at least two blades.
